(19) United States
(12) Patent Application Publication
(10) Pub. No.: US 2012/0282985 A1
(43) Pub. Date: Nov. 8, 2012

(54) BELTED GRAIN TANK FLOOR

(76) Inventors: Bruce A. Coers, Hillsdale, IL (US); Daniel J. Burke, Cordova, IL (US); Ryan P. Mackin, Milan, IL (US); Shane Anderson, Syracuse, UT (US); David Rix, Sandy, UT (US); Cody Freehill, Fenton, IL (US)

(21) Appl. No.: 13/280,091

(22) Filed: Oct. 24, 2011

Related U.S. Application Data
(63) Continuation-in-part of application No. 12/173,583, filed on Jul. 15, 2008, now abandoned.

(51) Int. Cl. A01F 12/46

(52) U.S. Cl. 460/114

(57) ABSTRACT

A grain tank on a crop harvester includes a belted conveyor floor for moving grain in the grain tank toward an opening through which the grain tank is emptied. A sensor determines when the grain has depleted the tank to a substantially low level and activates the floor to remove the remainder of the grain material. A flexible strip between the active floor and the sidewalls of the grain container ensure that grain loss is minimized, if not eliminated. The active floor may be provided in an belt in which the driven side has a lower friction material so as to improve belt life.

### CROSS REFERENCE TO RELATED APPLICATIONS

This is a continuation-in-part application of non-provisional application Ser. No. 12/173,583, entitled “Belted Grain Tank Floor,” filed on Jul. 15, 2008, which is incorporated herein by reference.

### FIELD OF THE INVENTION

The present invention relates to agricultural harvesters, and, more particularly to grain tanks in such harvesters.

### BACKGROUND OF THE INVENTION

Agricultural harvesters, such as combines, include a head and a feeder housing which remove the crop material from the field, gather the crop material and transport the crop material to a separator in the harvester. The separator removes the grain crop material from the non-grain crop material. The grain is cleaned and deposited in a grain tank on the harvester. When the grain tank becomes full, the combine is positioned adjacent a vehicle into which the grain is to be unloaded, such as a semi-trailer, gravity box, straight truck, or the like; and an unloading system on the combine is actuated to transfer the grain into the vehicle.

It is known to provide a door at the bottom of a grain tank on a harvester and a conveyor adjacent to the door opening for transporting grain from the grain tank to an auger also on the harvester, for subsequent transport by the auger to the vehicle. It is known to drain the grain by gravity flow from the grain tank onto the conveyor. It is known to slope the walls and the floor of the grain tank to promote gravity flow of the grain through the door opening.

A trend in agricultural machines is for the size of the machines to become larger, reducing the number of passes required to cover a field. As the harvester width is increased, more grain is harvested during each pass over the field. Accordingly, it is desirable to increase the grain tank capacity to maximize productive crop harvesting time between unloading events. In many situations it is necessary to stop the harvester for unloading. Accordingly, it is desirable to reduce the frequency of unloading and to increase unloading efficiency to minimize the time required for unloading, and thereby maximize harvesting efficiency.

Providing sloped sides and a sloped floor reduces the grain tank storage volume for the footprint of the grain tank on the harvester. Grain tank capacity can be increased by simply increasing the height of the grain tank. However, this raises the center of gravity, which is undesirable.

Unloading by gravity flow can be unreliable and inefficient. The grain tanks do not always empty completely, and it may be necessary to clean the grain tank manually when switching between different crops. Further, as the grain tank empties, the discharge rate from the grain tank decreases, and considerable time may be required to remove a small volume at the end of the emptying cycle when emptying the grain tank by gravity flow.

What is needed in the art is a grain tank on a harvester with increased capacity for the footprint of the grain tank on the harvester, and a grain tank that empties quickly and reliably.

### SUMMARY OF THE INVENTION

The present invention provides a grain tank with an active floor that can be actuated to transport grain in the grain tank toward the door opening in the grain tank.

The invention in one form is directed to a grain tank for an agricultural crop harvester having a plurality of sides defining a space in which grain is accumulated. A door is operable in an opening of the grain tank in one of the sides to selectively cover and uncover the opening. An active floor between the sides is selectively operable to transport grain on the floor toward the opening.

The invention in another form is directed to a method for emptying a crop harvester grain tank. The method has steps of: opening a door near the bottom of the grain tank; draining grain from the grain tank by gravity flow through the open door; operating an active floor at the bottom of the grain tank; and moving grain toward the open door by operating the active floor.

The invention in still another form is directed to a crop harvester with a harvesting head and a body in which a crop is processed. A grain tank on the body receives processed grain. An opening is provided in the grain tank, and a door on the grain tank is operable to cover and uncover the opening. A conveyor adjacent the opening moves grain received through the opening away from the grain tank. An active floor in the grain tank moves grain in the grain tank toward the opening.

### BRIEF DESCRIPTION OF THE DRAWINGS

FIG. 1 is a perspective view of an agricultural harvester which includes an embodiment of a belted grain tank floor of the present invention;

FIG. 2 is a fragmentary perspective view of the top of the harvester shown in FIG. 1;

FIG. 3 is a perspective view of a grain tank having a belted floor in accordance with the present invention;

FIG. 4 is a cross-sectional view of the grain tank shown in FIG. 3, illustrating the grain tank open for emptying; and

FIG. 5 is a cross-sectional view similar to that of FIG. 4, but illustrating the door of the grain tank closed.

### DETAILED DESCRIPTION OF THE INVENTION

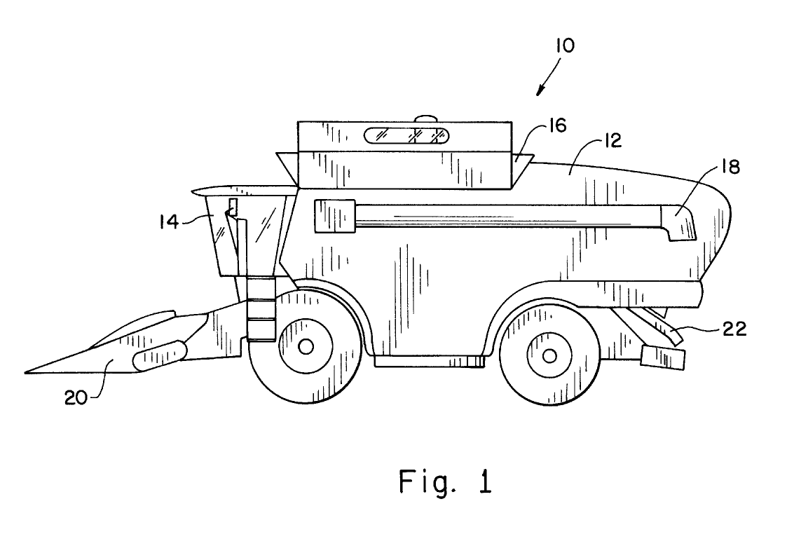

Referring now to the drawings, and more particularly to FIG. 1, there is shown an embodiment of an agricultural harvester 10. Harvester 10 generally includes a body 12, an operator cab 14, a grain tank 16 and an unloading auger 18. Harvester 10 is detachably coupled with a cutting platform or head 20 in front of operator cab 14. A crop material is removed from the field by head 20 and transported from head 20 into a separator within harvester 10. The grain is separated from the non-grain or refuse crop material, with the grain being transported into grain tank 16 and the non-grain refuse crop material being discharged back onto the field via a straw chopper 22.

Grain tank 16 receives grain from an auger 24, and may include a plurality of covers 26, 28 over the top thereof. A cross conveyor 30 at an end of grain tank 16 receives grain from grain tank 16 and transports the grain to unloading auger 18. FIG. 2 illustrates grain tank 16 in an opened condition to expose cross conveyor 30 during an unloading operation. An active floor 32 is provided in the bottom of grain tank 16 for active transport of grain thereon toward cross conveyor 30.

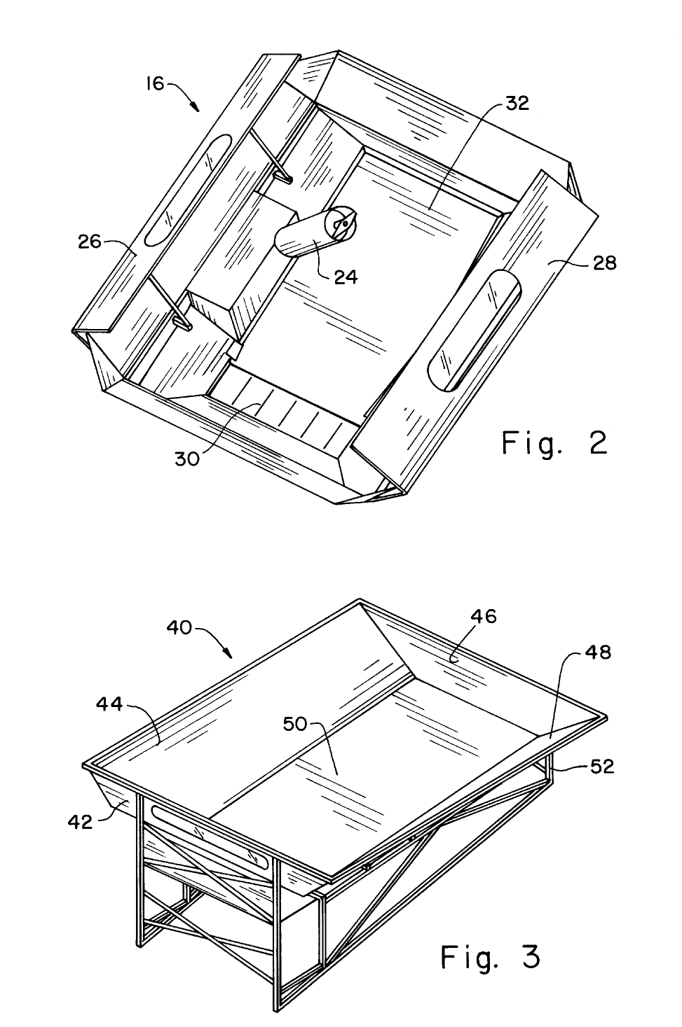

A simplified illustration of a grain tank 40 of the present invention is shown in FIG. 3. Grain tank 40 includes a plurality of side walls 42, 44, 46 and 48 defining a space for the receipt of grain therein. An active floor in the way of a belted conveyor floor 50 is provided at the bottom of grain tank 40 for actively transporting grain thereon. Other types of active floors also can be used, such as, for example, a drag chain. Grain tank 40 is supported in a harvester by a supporting framework 52 attached to harvester 10. Belted conveyor floor 50 forms the entire floor or bottom in grain tank 40, substantially spanning the entire area defined between the lower edges of side walls 42, 44, 46 and 48. A sensor 43 is positioned in side wall 42 adjacent the bottom edge of wall 42 at approximately the mid point thereof. Although the sensor 43 is shown as approximately one inch from the bottom edge of sidewall 42, it can be varied. Sensor 43 has, as its function, the determination that grain has dropped to a point where the grain tank 40 has significantly depleted. Sensor 43 may be a sensor of particles of grain but it may also be a pressure sensor detecting that the pressure on sidewall 42 has diminished to the point where the grain tank is significantly emptied. Sensor 43 is connected via line 45 to a controller 47 for operation in response to signals from sensor 43.

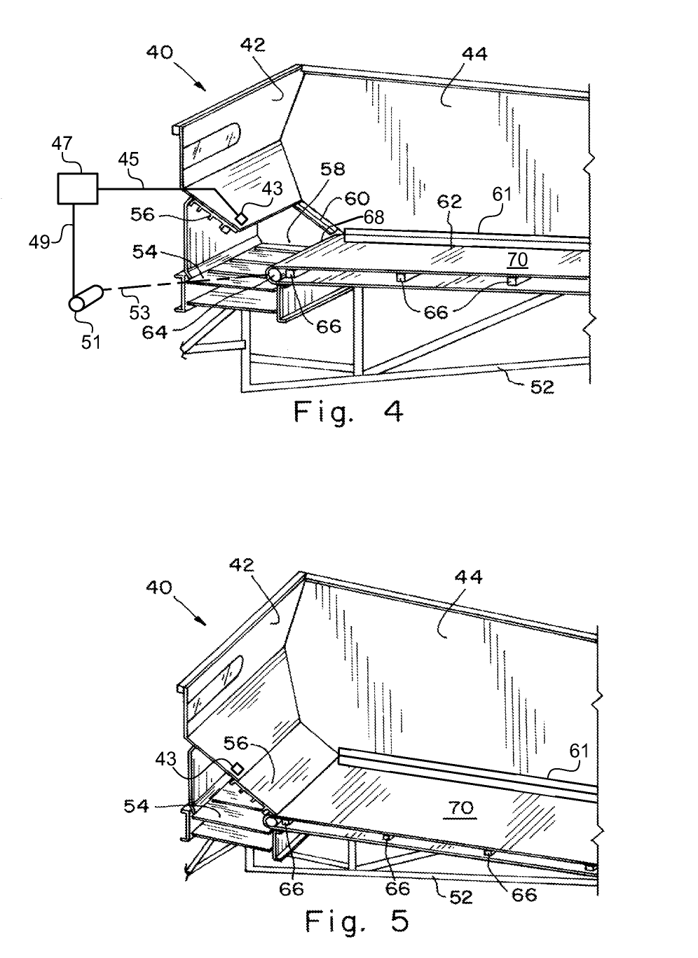

With reference now to the cross-sectional views of FIGS. 4 and 5, a cross conveyor 54 is provided at an end of grain tank 40. A door 56 is provided in an opening 58 through which grain flows from grain tank 40 to cross conveyor 54. Door 56 is a sliding door operable in channels 60, one of which can be seen in FIG. 4. It should be understood that a second channel similar to channel 60 is provided at the side of opening 58 opposite from the side illustrated in FIGS. 4 and 5.

Belted conveyor floor 50 is a looped endless belt conveyor having an endless belt 62 supported about rollers 64 and support members 66. Belt 62, in practice, may be a seamed belt with ends appropriately fastened either before final installation or after. Support members 66 span the distance from one side wall to an opposite side wall of tank 40, and are disposed between upper and lower runs of looped endless belt 62. Support members 66 provide support to endless belt 62 having grain loaded thereon. Roller 46 is driven by an appropriate motor 51 through mechanical interconnection and receiving inputs from controller 47 via line 49. Motor 51 may be an electrical motor or hydraulic motor or other device imparting rotary movement to roller 64 in response to inputs from controller 47.

Belted conveyor 50 extends through opening 58 and has a discharge end 68 thereof positioned over cross conveyor 54. As can be seen in FIG. 5, door 56 closes opening 58 and slides against an upper surface 70 of belt 62. Even if some grain slides between belt 62 and door 56, since discharge end 68 of belted conveyor floor 50 overlies cross conveyor 54, the grain will accumulate on cross conveyor 54 for subsequent transport to unloading auger 18 during a next unloading operation, and the grain, thereby, is not lost. In order to minimize, if not eliminate, the loss of grain between the active floor 50 and the sidewalls 44 and 48, a flexible strip 61 is provided, which is appropriately attached to sidewalls 44 and 48 and which has a sliding overlapping interconnection with the side edges of endless belt 50. Strip 61 is formed from flexible relatively thin material with a top side formed from elastomeric or rubber like material and a bottom side, exposed to the belted conveyor floor 50, formed from material such as woven nylon, with an appropriate low coefficient of friction with respect to belt 50. Although not specifically limited, the material commercially sold under the model number Type Code 61 by All State, Inc., may be used for this purpose. The tape 61 ensures that any grain on the sidewalls 44 and 48 will be directed to the belt 50 for delivery to the opening 58.

In addition, belt 50, while having a suitable elastomeric, relatively high friction material on its outer facing side, has an absence of such material on the inner side facing roller 64 and cross supports 66. Typically, the belt 50 would be made from interlaced fiber material coated with rubber on the exterior. Such a belt would not have a rubber coating on the interior so as to minimize friction.

During an unloading operation, it is not necessary to operate an active floor of the present invention during the entire unloading process. The unloading operation is commenced by opening the door and draining grain from the grain tank by gravity flow through the door opening. For opening, the door is slid in the channels to uncover the opening and allow grain to drain from the grain tank by gravity flow. The grain tank discharge rate, which is the flow rate of grain from the grain tank, decreases as the grain tank empties. When the discharge rate decreases a significant amount, the active floor can be operated to transport grain thereon toward and through the grain tank opening to be dumped onto the cross-conveyor. The sensor 43, positioned closely adjacent opening 58, senses when the grain level has progressed to that level and, as such, sends a signal to controller 47 to operate motor 51 to drive roller 64. When sensor 43 is a pressure sensor, it responds to the absence of pressure to cause controller 47 to operate motor 51 at a point when the grain load on active floor is significantly decreased. In another from, sensor 43 may be a simple on/off switch covered by a membrane and exposed to the grain so that when the grain level drops below the sensor 43, the switch closes. As a result, the drive motor for roller 64 can be significantly smaller in terms of its maximum output than is needed if the entire contents of the grain tank 40 were evacuated using the active floor 50. Furthermore, the strip 61 on the sidewalls ensures that all of the grain is directed to the active floor 50 and that it is not lost on the side.

By not using a high friction material on the roller side of endless belt 62, the driving forces for the belt are minimized to increase its longevity. This is possible by the activation of the active floor only when the amount of grain in the floor has reached the minimal level as sensed by the sensor 41. Even only a slow, steady rotation of the endless belt will improve the grain tank emptying efficiency by actively moving the grain on the floor toward and through the door opening.

The walls of the grain tank can be angled inwardly slightly to promote flow and emptying; however, the walls need not be severely sloped nor need the floor be sloped toward the door opening. The active floor can be positioned substantially horizontally at the bottom of the sidewalls. Accordingly, in comparison to previously known grain tank designs with angled walls and an angled floor, the capacity of the grain tank of the present invention is increased without increasing the foot print of the grain tank on the harvester, and without increasing the grain tank height. Accordingly, capacity is increased while at the same time reducing the center of gravity in that the increased tank volume is achieved at the bottom of the grain tank. Since the grain in the grain tank is actively transported to the opening and does not rely completely on gravity drainage, emptying the grain tank is both efficient and thorough.

Having described the preferred embodiment, it will become apparent that various modifications can be made without departing from the scope of the invention as defined in the accompanying claims.

1. A method for emptying a crop harvester grain tank, said method comprising steps of:
opening a door near the bottom of the grain tank;
draining grain from the grain tank by gravity flow through the open door;
sensing when the grain tank is significantly emptied;
operating an active floor at the bottom of the grain tank in response to the sensing of the grain tank being significantly emptied; and
moving grain toward the open door by operating the active floor.

2. The method of claim 1 said step of operating an active floor including rotating an endless belt.

3. The method of claim 2, said step of operating an active floor is initiated by a motor driving the endless belt, said motor having a capacity significantly lower than the capacity to operate the belt with a full load of grain.

4. The method of claim 3, said step of operating an active floor including a controller receiving signals from a sensor on said grain tank and controlling the operation of said motor

5. The method of claim 4, wherein said sensor is responsive to pressure reflecting the absence of grain.

6. The method of claim 4, wherein said sensor is responsive to pressure on at least one of the walls of the grain tank.

7. A crop harvester, comprising:
a harvesting head and a body in which a crop is processed;
a grain tank on said body for receiving grain;
an opening in said grain tank and a door operable to cover and uncover said opening for initial depletion by gravity;
a conveyor adjacent said opening to receive grain from said tank through said opening;
a sensor positioned in said grain tank providing a signal when the level of grain therein is substantially depleted; and
an active floor in the grain tank for selectively moving grain in said grain tank toward said opening in response to an input from said sensor for removing remaining grain from said grain tank.

8. The crop harvester of claim 7, said door comprising a sliding door.

9. The crop harvester of claim 7, said active floor comprising a rotatable endless belt.

10. The crop harvester of claim 9, said rotatable endless belt extending through said opening.

11. The crop harvester of claim 10, said rotatable endless belt having a discharge end over said conveyor.

12. The crop harvester of claim 10, said rotatable endless belt substantially spanning said grain tank.

13. The crop harvester of claim 9, further comprising a motor for driving said endless belt in response to an input from said sensor.

14. The crop harvester of claim 13, wherein the capacity of said motor is significantly less than the capacity required to move grain from said grain tank when it is substantially fully loaded.

15. The crop harvester of claim 14, further comprising a controller connected to and receiving inputs from said sensor and operable to control the operation of said motor in response to inputs form said sensor.

16. The crop harvester of claim 9, wherein said grain tank has side walls extending downward to the side edges of said endless belt and said crop harvester further comprises a flexible tape on each said wall secured thereto and overlapping said endless belt.

17. The crop harvester of claim 16, wherein said tape is thin.

18. The crop harvester of claim 17, wherein said tape has a low friction surface overlapping said endless belt.

19. The crop harvester of claim 9, wherein said endless belt has an elastomeric outer covering with a high coefficient of friction and an inner covering with a low coefficient of friction.
